(19) United States
(12) Patent Application Publication
(10) Pub. No.: US 2021/0315778 A1
(43) Pub. Date: Oct. 14, 2021

(54) AUTOMATIC FEEDING APPARATUS

(71) Applicant: Mesut Kilinc, Roxburgh Park (AU)

(72) Inventor: Mesut Kilinc, Roxburgh Park (AU)

(21) Appl. No.: 17/225,917

(22) Filed: Apr. 8, 2021

(30) Foreign Application Priority Data
Apr. 9, 2020 (AU) 2020901145

(51) Int. Cl. A61J 9/06; A61J 9/04; A61J 9/00

(52) U.S. Cl. CPC A61J 9/0684; A61J 9/006; A61J 9/04

(57) ABSTRACT

An automatic feeding apparatus includes a bottle for holding liquid, a tube connected to the bottle, and a teat connected to the tube. A characterizing feature of the system is that the bottle has an air-intake mechanism adapted to release the liquid within the bottle through the tube to the teat.

### BACKGROUND

### Field of the Invention

The present invention relates to the consumer products industry and, more particularly to a baby's bottle capable of automatically drip feeding the baby.

### Description of Related Art

Newborn babies and small infants typically must be held whilst a carer holds a bottle to feed them. A feeding session can last approximately 15 to 20 minutes, depending on the appetite of the baby.

It can be difficult for the carer to hold the baby in position for 15 to 20 minutes. In the absence of air conditioning, the carer can become overheated from the body heat of the baby and vice versa. Some babies are particularly sensitive to movements during the feeding sessions, such that if the carer moves the baby, or repositions themselves, the baby begins to cry.

Some mothers have had caesarean section operations, so holding the baby on their lap to bottle feed it or breast feeding the baby can put pressure on the caesarean section wound.

In many instances the baby would be more comfortable if it was left alone to feed. However, newborn babies and small infants are mostly incapable of bottle feeding themselves.

It would be advantageous if there was a means of automatically feeding a newborn baby or small infant.

The object of the present invention is to overcome or at least substantially ameliorate the aforementioned problems.

### SUMMARY OF THE INVENTION

According to the present invention, there is provided an automatic feeding apparatus, the apparatus comprising:
(a) a bottle for holding liquid;
(b) a tube connected to the bottle; and
(c) a teat connected to the tube,
   wherein the bottle has an air-intake mechanism adapted to release the liquid within the bottle through the tube to the teat.

Preferably the air-intake mechanism is a twistable base adapted to be twisted off the bottle to release the air-pressure holding the liquid inside the bottle. However, the air-intake mechanism may alternatively comprise an openable valve to release the pressure.

It is preferred that the apparatus further includes a stand to hold the bottle in an elevated position above the user. The stand may have a clamp to hold the bottle upside down. Preferably, the clamp has a swivel mount on the stand so that the bottle can be turned up or down within the clamp.

The tube is connected to the top of the bottle and gravity, along with air releasing base facilitates the supply of liquid to the user through the teat.

Preferably the bottle has a rubber seal and spigot to enable the tube to be attached to the bottle without it leaking whilst the bottle is in an upside position.

### BRIEF DESCRIPTION OF DRAWINGS

An embodiment of the invention will be described with reference to the following drawings, in which:

FIG. 1 is a perspective view of a first embodiment of a bottle-feeding apparatus according to an embodiment of the present invention.

FIG. 2 is a side perspective view of the bottle of FIG. 1 with the air releasing base detached from the bottle.

FIG. 3 is a side perspective view of the bottle of FIG. with the air releasing base separate from the bottle.

FIG. 4 is a side section perspective view of the bottle of FIG. 1.

FIG. 5 is a side perspective view of the bottle of FIG. 1, with the lid detached from the bottle.

FIG. 6 is a perspective view of the teat in the apparatus of FIG. 1.

FIG. 7 is a close-up perspective view of a bottle according to second embodiment of the present invention.

FIG. 8 is a side section perspective view of the bottle of FIG. 7.

FIG. 9 is an exploded perspective view of the bottle of FIG. 7.

FIG. 10 is a side section view of the bottle of FIG. 7.

### DETAILED DESCRIPTION OF THE INVENTION

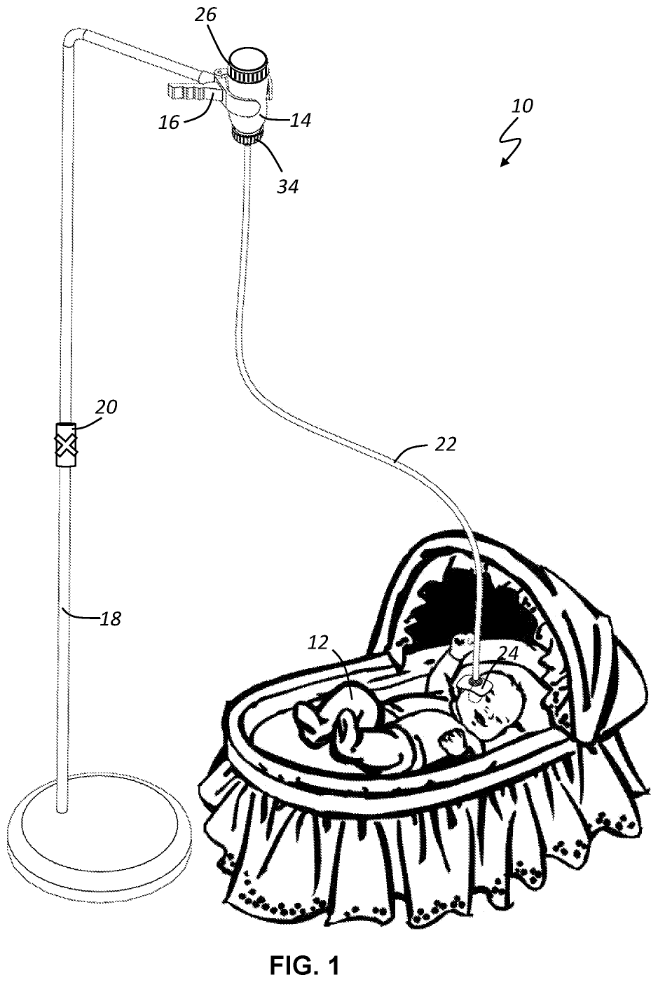

FIGS. 1 to 6 show a first embodiment of an automatic feeding apparatus 10 according to the present invention for a baby 12. The apparatus 10 includes a bottle 14. The bottle 14 can be positioned upright in a clamp 16 on stand 18 which has a heavy base 20. The stand 18 has a height adjustment mechanism 20. The stand 18 should be positioned out of reach of the baby 12. The clamp 16 has a swivel mount on the stand 18. When the baby 12 is ready to be fed, the clamp 16 can be turned so that the bottle 14 is repositioned upside down. Liquid within the bottle 12 passes through a tube 22 to the teat 24, which is sucked by the baby 12.

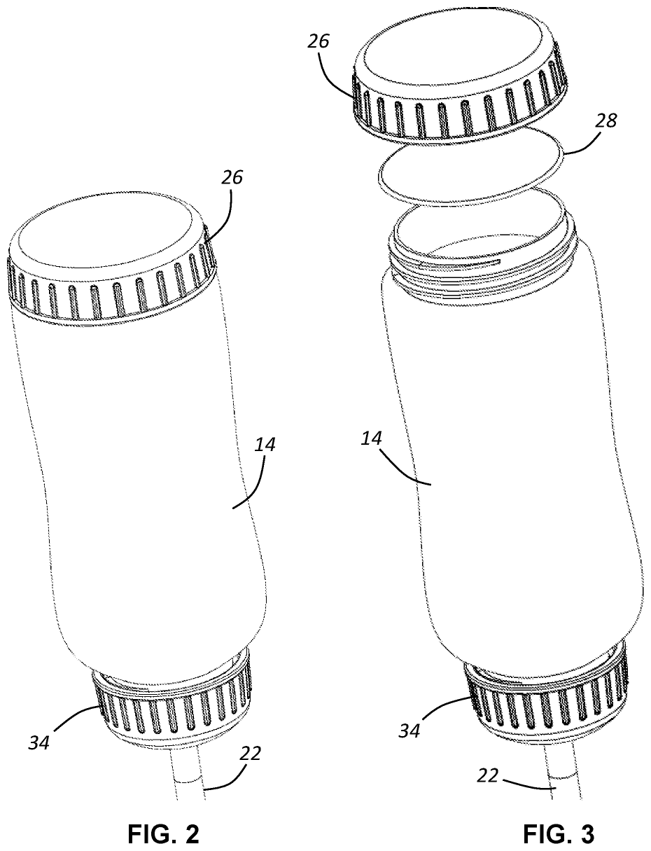

Referring to FIG. 2, the bottle 14 has a twistable base 26 that can be turned in order to let air into the bottle. In prior art feeding systems, it can be difficult for a baby to suck the liquid through the teat of the bottle. Often the teat depresses within the bottle and the baby has to detach from the teat for it to reinflate. This is because the drain of liquid from within the bottle creates negative air pressure. Teat depression can be a source of considerable frustration for a baby, particularly a newborn baby that may expect a constant flow of liquid (like from a breast). Swallowing air during feeding can give the baby excess gas, which can upset their stomach. It requires the carer to burp the baby regularly during and after the feeding session. The twistable base 24 of the present invention creates corresponding positive pressure to avoid this problem.

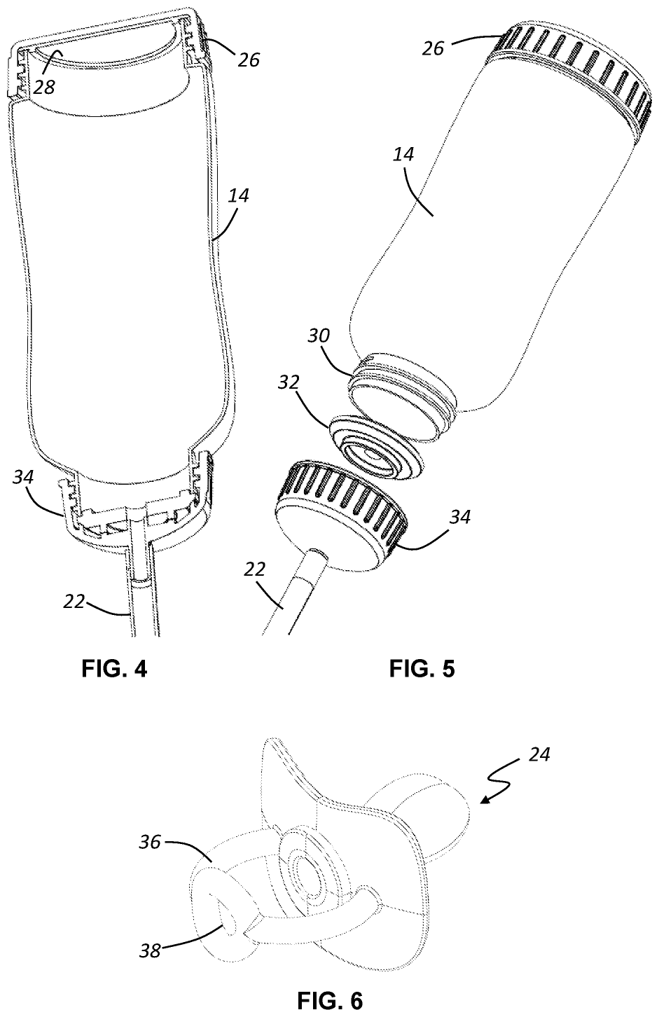

An exploded view of the twistable base 26 of the bottle 14 is shown in FIG. 3. The twistable base 26 includes a rubber seal 28 to help to prevent the escape of liquid from the base 24 when the base 24 is firmly attached to the bottle 14. A cross sectional view of the bottle 14 is shown in FIG. 4. The head 30 of the bottle 14 connects with rubber seal 32 and a cap 34.

When in use, the carer puts baby formula powder into the bottle 14 through either the head or the base of bottle 14. Water is then added to the formula. The bottle 14 can then be shaken to mix the formula into the water. The bottle 14 can be positioned upside down and the base can be slightly unscrewed so that it can release air into the bottle to prevent the creation of a vacuum within the bottle 14 that would otherwise impede the flow of the liquid out of the top of the bottle 14. The apparatus 10 has a customised teat 24 which has a handle 36 that features an orifice 38 to allow the ingress of the tube 22.

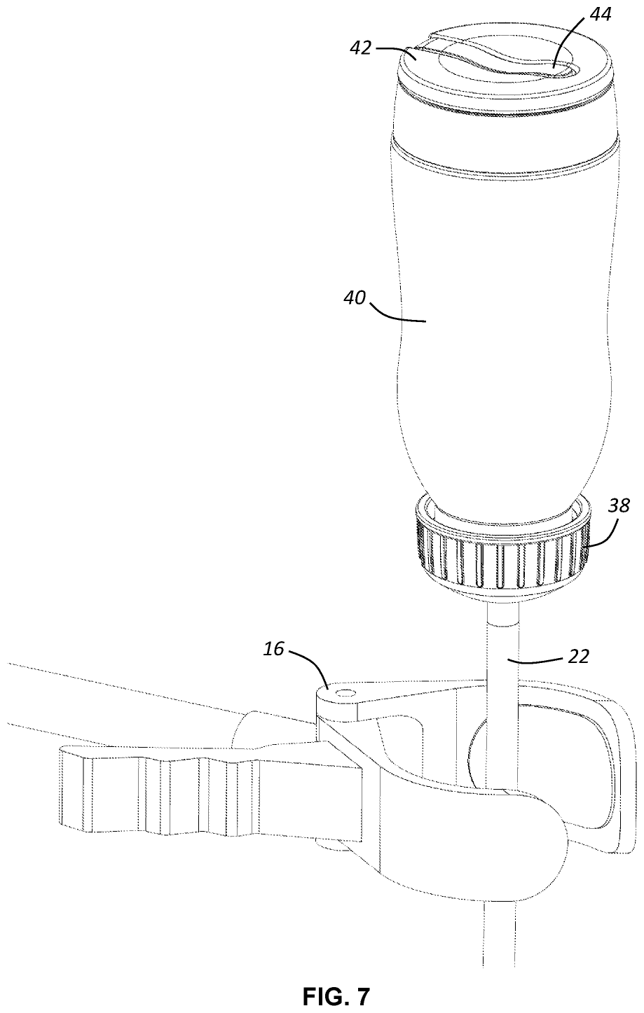

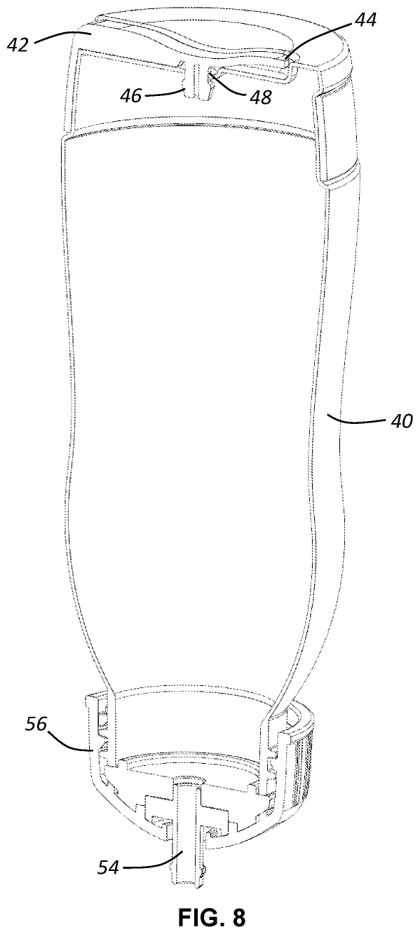

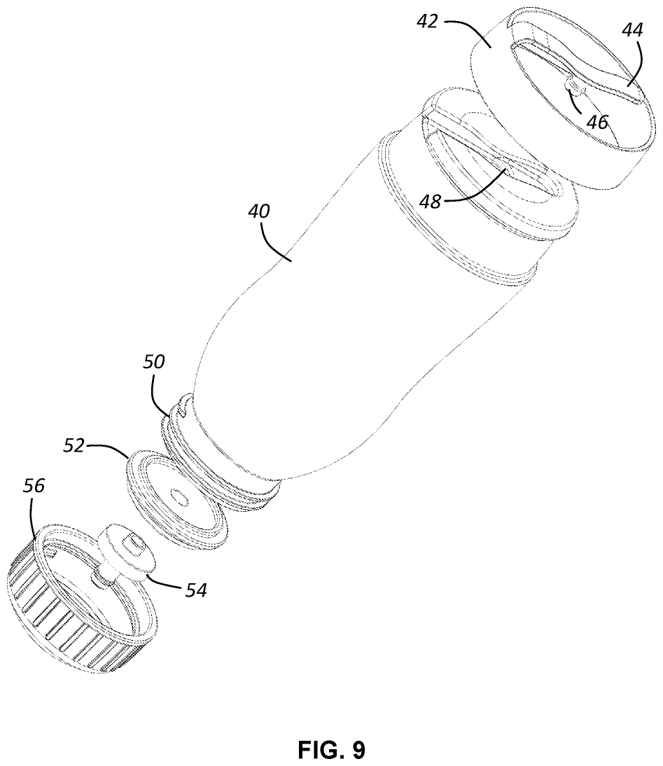

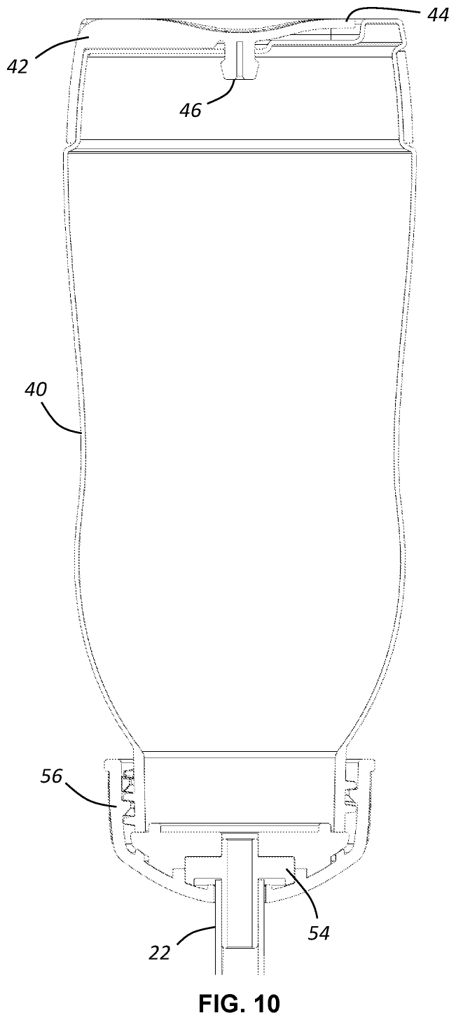

FIGS. 7 to 10 show a second embodiment of the invention. In this embodiment of the invention, the bottle 40 has a valve 42 with a latch 44 having a plug 46 for an aperture 48. The aperture 48 allows air pressure to push the liquid within bottle 40 through the tube 22. This facilitates the flow of liquid to the teat 24 for the baby 12.

The bottle 40 also has a rim 50 and a rubber seal 52 which stops liquid from leaking out of the bottle 40. A spigot 54 connects with a hole in the rubber seal 52. The spigot 54 enables the tube 22 to be connected to the bottle 40. The spigot 54 penetrates a hole in the cap 56.

Both the openable valve 42 and the twistable base 26 constitute an air-intake mechanism adapted to release the liquid within the bottle through the tube to the teat. The air-intake mechanism constitutes the characterizing feature of the present invention over the prior art.

After all the liquid has been finished from the bottle, the baby 14 can enjoy continuing to suck on the teat 24 and breathing through it because of the open valve 42 or twistable base 26.

The present invention allows a carer to feed the baby automatically without coming in touch contact with the baby throughout the feeding process. The present invention provides a more comfortable experience for both carer and baby than in any prior art feeding systems.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. An automatic feeding apparatus comprising:
(a) a bottle for holding liquid;
(b) a tube connected to the bottle; and
(c) a teat connected to the tube,
wherein the bottle has an air-intake mechanism adapted to release the liquid within the bottle through the tube to the teat.

2. The apparatus of claim 1, wherein the air-intake mechanism comprises a twistable base.

3. The apparatus of claim 1, wherein the air-intake mechanism comprises an openable valve.

4. The apparatus of claim 1, wherein the automatic feeding apparatus further comprises a stand for holding the bottle in an elevated position above a user feeding from the bottle.

5. The apparatus of claim 4, wherein the stand comprises a clamp for holding the bottle.
